(19) United States
(12) Patent Application Publication
(10) Pub. No.: US 2008/0284258 A1
(43) Pub. Date: Nov. 20, 2008

(54) Chassis Component

(76) Inventors: Joachim Spratte, Osnabruck (DE); Michael Klank, Osnabruck (DE)

Correspondence Address: MCGLEW & TUTTLE, PC, P.O. BOX 9227, SCARBOROUGH STATION, SCARBOROUGH, NY, 10510-9227, US

(21) Appl. No.: 10/596,346

(22) PCT Filed: Dec. 9, 2004
(86) PCT No.: PCT/DE2004/002695

§ 371 Date: Jun. 9, 2006

(30) Foreign Application Priority Data
Dec. 12, 2003 (DE) 103 58 764.0

(51) Int. Cl. H02K 35/02

(52) U.S. Cl. 310/25

(57) ABSTRACT

Chassis part of a vehicle, with a magnet (2) and at least one electric coil (10), which interacts with the magnetic field generated by the magnet (2), wherein the magnet (2) and the coil (10) are mobile in relation to one another. The chassis part (13) can perform vibrations with at least one natural frequency, wherein the magnet (2) is fastened to a spring (8) and is mobile relative to the coil (10), and wherein the natural frequency of the oscillator (14) having the magnet (2) and the spring (8) is tuned to the natural frequency of the chassis part (13).

### CROSS REFERENCE TO RELATED APPLICATIONS

This application is a United States National Phase application of International Application PCT/DE 2004/002695 and claims the benefit of priority under 35 U.S.C. § 119 of German Patent Application DE 103 58 764.0 filed Dec. 12, 2003, the entire contents of which are incorporated herein by reference.

### FIELD OF THE INVENTION

The present invention pertains to a chassis part of a vehicle, with a magnet and at least one electric coil, which interacts with the magnetic field induced by the magnet, wherein the magnet and the coil are mobile in relation to one another.

### BACKGROUND OF THE INVENTION

Electronic control systems, which also require sensor systems on moving parts of the axles, have been increasingly used in chassis of motor vehicles. However, sensors in the moving parts of the axles have the drawback that a cable connection is necessary from the body to the sensor, which implies the risk of cable break. Radio systems are therefore increasingly used to transmit the signals sent by the sensor. However, sensor systems with integrated signal processing have a relatively high power consumption, so that energy transmission via a radio connection should be assessed critically. Power supply via a battery is available for such systems, but this has the drawback that a battery must be replaced in the course of the service life of the vehicle and additional maintenance operations are thus necessary.

Generators, which utilize the motions of the vehicle to generate electric energy, have been created for this reason.

DE 195 20 521 A1 discloses a navigation system for vehicles, with a navigation device, which has a battery, a loading circuit connected to the battery, and a means, which is connected to the loading circuit and in which a random vibrating motion originating from the normal progressive motion of the vehicle is converted into electric energy. A carrier structure is held between two spiral springs in a housing of the means, so that a back and forward motion of the carrier structure relative to the housing in the direction of a vibration axis is possible in response to a vibrating motion. Magnets, opposite which coils arranged on the side walls of the housing are located, are arranged at the side walls of the carrier structure.

It is known from DE 196 47 031 A1 that the lifting piston of a shock absorber for a motor vehicle can be equipped with a magnet, which can move, for generating electric energy, in a plurality of coils, which are arranged on the outer side of a protective tube made of a nonmagnetic material. The shock absorber may be arranged in a spring to form a combination of a spring and an absorber.

DE 198 16 454 A1 discloses a device for monitoring vehicle tires, with a scanning head, whose motion is transmitted via a bar to a permanent magnet, which induces a voltage in a coil surrounding it. The voltage is rectified and smoothed and subsequently fed into a storage capacitor. The device is arranged in the vehicle tire, and the scanner is actuated only when the tire pressure is too low.

DE 199 34 263 A1 discloses an assembly unit for a vehicle, with a sensor, an electronic evaluating unit, a radio transmission means and a power supply of its own, which assembly unit utilizes the relative motion between a magnet and a coil and stores the electric energy obtained in a capacitor. The assembly unit may be arranged with [sic—Tr.Ed.] a component connected to the axle.

### SUMMARY OF THE INVENTION

Based on this state of the art, the basic object of the present invention is to improve the chassis component of the type described in the introduction such that electric energy is generated by it possibly continuously during the travel of the vehicle.

According to the invention, a chassis part of a vehicle is provided with a magnet and at least one electric coil, which interacts with the magnetic field generated by the magnet. The magnet and the coil are mobile in relation to one another. The chassis part can perform vibrations at least one natural frequency. The magnet is fastened to a spring and is mobile relative to the coil. The natural frequency of the oscillator having the magnet and the coil is tuned to the natural frequency of the chassis part.

Chassis of vehicles, especially motor vehicles, usually have a wheel, a spring-absorber unit with connection elements, e.g., control arms. These chassis parts usually have at least one natural frequency, at which they vibrate during each shock-like excitation of the vehicle. Since shock-like excitations occur very frequently during the travel of the motor vehicle, these chassis parts, which are able to vibrate, vibrate quasi-continuously at their natural frequencies during travel. These vibrations are prevented from being coupled into the body by means of corresponding absorber elements.

The chassis part according to the present invention takes advantage of these vibrations and has a magnet and at least one electric coil, which interacts with the magnetic field generated by the magnet, the magnet and the coil being mobile in relation to one another. The chassis part can perform vibrations at least one natural frequency, and the magnet is fastened to a spring and can be moved relative to the coil. The natural frequency of the oscillator having the magnet and the spring is tuned to the natural frequency of the chassis part.

When shock is induced, the chassis part performs a vibration at its natural frequency or at one of its natural frequencies, as a result of which the oscillator formed by the spring and the magnet is likewise induced to vibrate. Based on the vibration of the magnet, an electric current or electric voltage is generated in the coil, so that electric energy can be made available or supplied by the chassis part according to the present invention quasi-continuously during travel.

The natural frequency of the oscillator depends especially on the weight of the magnet and the spring rate of the spring, so that the natural frequency of the oscillator can be tuned to the natural frequency of the chassis part by properly selecting the weight of the magnet and the spring rate. The oscillator should be as small as possible compared to the dimensions of the chassis part and have the lowest possible weight compared to the weight of the chassis part, so that the feedbacks of the oscillator to the vibration properties of the chassis part will be small. The term “tuned” should be defined, in particular, as the condition under which the natural frequency of the oscillator agrees with the natural frequencies of the chassis part. The chassis part may be designed now, e.g., as a control arm or hinge. However, it is also possible that the chassis part is composed of a group of individual components, which has, as an assembly unit, one or more natural frequencies. A vehicle wheel or tire may also be part of such an assembly unit.

The magnet is guided especially displaceably in a sleeve, so that the magnet can vibrate exclusively in the direction of the longitudinal axis of the sleeve. The magnet is preferably fastened in a sliding means in this case, so that the jacket surface of the sliding element is in sliding contact with the inner wall of the sleeve. This offers the advantage that the friction between the sleeve and the sliding means can be set to a very low value by properly selecting the material and by suitable surface treatment. The sliding element and/or the sleeve are preferably made of a nonmagnetic material, so that the magnetic field of the magnet is compromised as little as possible.

The spring may be designed as a coil spring, which is arranged especially concentrically around the sleeve. The spring is preferably fixed axially between outer shoulders arranged at the ends of the sleeve and may be pretensioned in the longitudinal direction.

Brackets, which pass through the wall of the sleeve and are fastened to the spring, may be formed on the sliding elements. Longitudinal slots, through which the brackets extend, may be provided in the wall of the sleeve for this purpose. However, the sleeve preferably has a two-part design, a distance being provided between the two parts of the sleeve in the axial direction. This distance is, in particular, smaller than the longitudinal extension of the sliding element, and the brackets pass through it.

If the magnet is vibrating, the distance between the magnet and the electric coil changes nearly periodically, so that an alternating electric current or alternating electric voltage is induced in the coil because of the change resulting from this in time in the magnetic flux flowing through the electric coil. One electric coil is sufficient for this, in principle. However, a second electric coil is preferably provided, and the magnet is arranged especially in the direction of vibration between these two electric coils, which can electrically interact in a suitable manner. Each coil may have a core made of a magnetic material, and the two cores may be connected to one another via a housing made of a magnetic material. This arrangement is favorable for the course of the magnetic field, and the magnetic material is especially a ferromagnetic material. The magnet, the spring and the two coils and optionally the sliding element and the sleeve may be arranged in the housing in this case, so that the oscillator is protected against the penetration of dirt and moisture. The front sides of the housing are preferably closed by the two coils or the coil cores.

An electric generator is formed from the oscillator and the coils, and the electric energy generated by this generator can be stored in a capacitor. Super-Cap capacitors are especially suitable for this, because these can store large quantities of electric energy. Furthermore, it proved to be advantageous to use Super-Cap capacitors with a low nominal voltage of, e.g., 2.3 V. If the electric generator is used for the power supply for, e.g., a sensor, it is possible to use a charging pump, which raises the voltage to the desired level, so that a sufficiently stable power supply is guaranteed.

However, it is also possible to use a chargeable battery instead of a capacitor as the electric energy storage means, in which case a charger can be arranged upstream of the battery.

The present invention will be described below on the basis of a preferred embodiment. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 shows a sectional view of an embodiment of the chassis part according to the present invention;

FIG. 2 shows a first electric block diagram of the chassis part according to the present invention; and

FIG. 3 shows a second electric block diagram for the embodiment according to FIG. 1.

### DESCRIPTION OF THE PREFERRED EMBODIMENTS

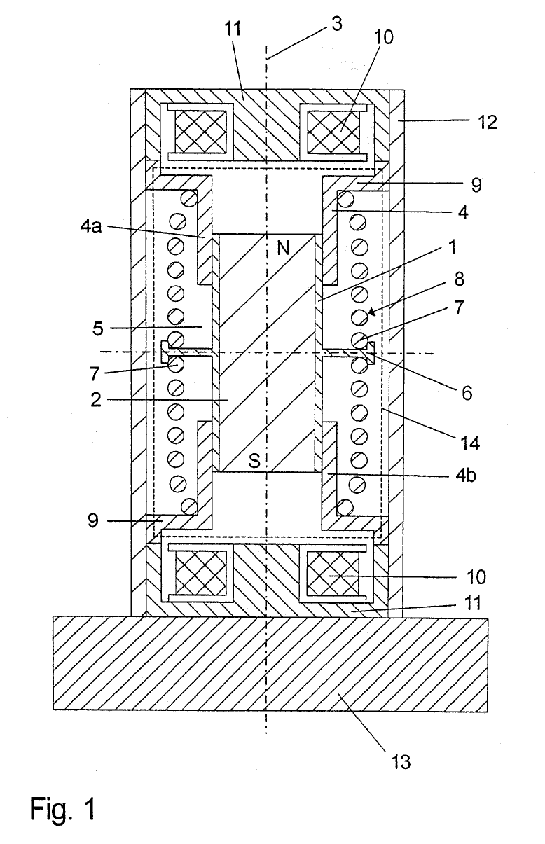

Referring to the drawings in particular, FIG. 1 shows an embodiment of the chassis part according to the present invention, where a magnet 2 fastened in a sliding element 1 is mounted in a sleeve 4 in such a way that it is slidingly movable in the direction of its longitudinal axis. The resulting magnetization of the magnet 2 designed as a permanent magnet extends on or in parallel to the longitudinal axis 3, the north pole N and the south pole S of the magnet 2 being shown in the figure.

The sleeve 4 has a two-part design, and a distance 5, through which passes a bracket 6 arranged at the sliding element 1, is provided in the axial direction between a first sleeve part 4a and the second sleeve part 4b. This bracket is fastened between two turns 7 of a spring 8, which is designed as a coil spring and is arranged concentrically around the sleeve 4. An outer shoulder 9 each is formed at the two ends of the sleeve 4, and the spring 8 is inserted under axial pretension between these two outer shoulders 9.

The sleeve 4 is arranged between two electric coils 10, which have a core 11 each and are fastened to the core, with each core 11 extending into the interior of the respective coil 10 and extending partially around same on the side facing away from the magnet 2. The two cores 11 are connected to one another via a housing 12, which is closed by the cores 11 on the front side. The cores 11 and the sleeve 4 are fixed at the housing 12.

The housing 12 or one of the cores 11 is fastened to the chassis part 13, which is shown schematically and is able to vibrate at least one natural frequency, so that mechanical vibrations of the chassis part 13 can be passed on to the housing 12 or the core 11. The oscillator 14, which is indicated by broken lines and has the spring 8, the magnet 2 and the sliding element 1, can thus be excited to perform vibrations in order to induce an electric current or an electric voltage in the coils 10. The spring rate of the spring 8 as well as the weights of the magnet 2 and of the sliding element 1 are selected to be such that the natural frequency of the oscillator 14 is tuned to one of the natural frequencies of the chassis part 13.

The magnetic coupling between the electric coils 10 and the oscillator 14 can lead to damping of the vibrating system, which can be taken into account in the design of the oscillator 14. However, this feedback is negligibly low in many applications.

The sliding element 1 and the sleeve 4 are preferably made of a nonmagnetic material, whereas the cores 11 and the housing 12 may consist of a magnetic, especially ferromagnetic material, which contributes to the flux concentration.

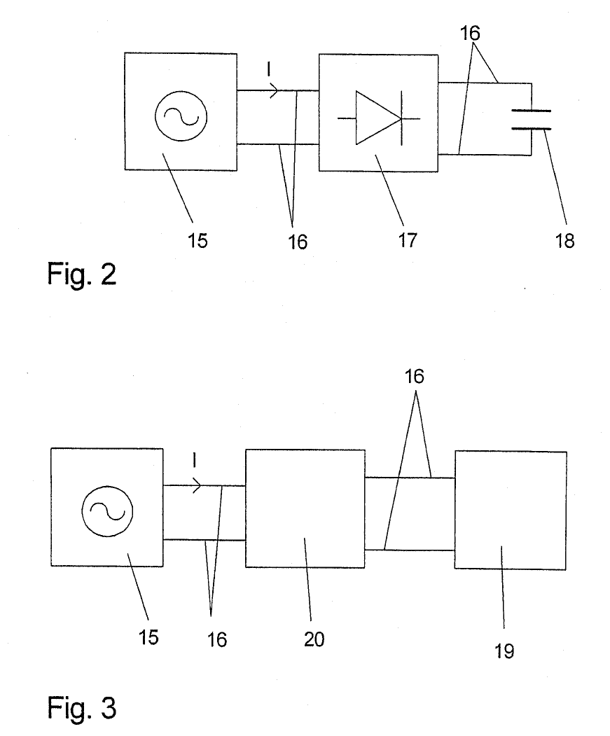

FIG. 2 shows an electric block diagram for the embodiment according to FIG. 1, in which the electric generator 15 formed from the oscillator 14 and the coils 11 is schematically shown. The electric current I induced in the coils 10 is tapped off via electric wires 16 and sent via a rectifier 17 to a capacitor 18, which acts as a storage means for the electric energy delivered by the generator.

As is apparent from FIG. 3, a chargeable battery 19 was used as the electric energy storage means instead of a capacitor, wherein a charger 20 is arranged upstream of the battery 19.

While specific embodiments of the invention have been shown and described in detail to illustrate the application of the principles of the invention, it will be understood that the invention may be embodied otherwise without departing from such principles.

1. A chassis part of a vehicle, the chassis part comprising:
a spring;
a magnet; and
at least one electric coil, which interacts with the magnetic field generated by the magnet, wherein the magnet and the coil are mobile in relation to one another, wherein the chassis part can perform vibrations at least one natural frequency, the magnet is fastened to said spring and is mobile relative to the coil, and the natural frequency of the oscillator having the magnet and the coil is tuned to the natural frequency of the chassis part.

2. A chassis part in accordance with claim 1, wherein the magnet is guided linearly movably in a sleeve made of a nonmagnetic material.

3. A chassis part in accordance with claim 1, wherein the magnet is fastened in a sliding element made of a nonmagnetic material.

4. A chassis part in accordance with claim 1, wherein the spring is a coil spring.

5. A chassis part in accordance with claim 1, wherein the magnet is arranged in the spring.

6. A chassis part in accordance with claim 1, wherein a second electric coil is provided and the magnet is arranged between the two electric coils.

7. A chassis part in accordance with claim 6, wherein the two electric coils have a core each made of a magnetic material, wherein the two cores are connected to one another via a housing made of a magnetic material.

8. A chassis part in accordance with claim 7, wherein the magnet, the spring and the two coils are arranged in the housing.
